(19) United States
(12) Patent Application Publication
(10) Pub. No.: US 2026/0240090 A1
(43) Pub. Date: Aug. 20, 2026

(54) IRRIGATION MANIFOLD WITH VARIABLE FLOW SHUT OFF VALVES

(71) Applicant: Husqvarna AB, Huskvarna (SE)

(72) Inventors: Ulises Harin Espinoza, Taylorsville, UT (US); Charles Spencer Donovan, Millcreek, UT (US)

(73) Assignee: Husqvarna AB, Huskvarna (SE)

(21) Appl. No.: 19/059,203

(22) Filed: Feb. 20, 2025

(51) Int. Cl. A01G 25/02; A01G 25/16

(52) U.S. Cl. CPC A01G 25/02; A01G 25/16

(57) ABSTRACT

An irrigation manifold may comprise a plurality of water outlets. Each outlet member may comprise a flow control member. Each flow control member may define an inlet opening, an outlet opening, and a flow control member passageway in fluid communication with both the inlet opening and outlet opening. Each flow control member may further comprise a flow control seal and downstream seal, which is downstream relative to the flow control seal. The flow control member, including the flow control seal, is rotatable between a fully obstructed range, a partially open range, and a fully open range.

### TECHNICAL FIELD

The present invention relates generally to a manifold. More specifically, the present invention relates to an irrigation manifold.

### BACKGROUND

Irrigation manifolds are useful in various scenarios, particularly in drip irrigation, where water is delivered to specific locations to minimize evaporation and directly hydrate the targeted vegetation rather than the surrounding soil. A manifold enhances this process by allowing a single water line to supply a location, which can then be redistributed to multiple areas within that location.

Additionally, the ability to control and/or shut off output lines from the manifold would be beneficial. Therefore, an improved mechanism for controlling or shutting off fluid flow through each output line of the manifold is desirable.

### SUMMARY

The following is a brief overview of the subject matter at issue and is in no way limiting of that subject matter at issue.

A first variation of an irrigation manifold is disclosed.

The first variation may comprise a main body having a fluid inlet and a plurality of water outlets.

Within the first variation, each water outlet may comprise an outlet member having an outlet member longitudinal axis. The outlet member may define a seal receiving chamber and an outlet fluid passageway. The outlet fluid passageway may be in fluid communication with the fluid inlet and the seal receiving chamber.

Within the first variation, each outlet may further comprise an outlet sleeve having an outlet sleeve longitudinal axis. The outlet sleeve longitudinal axis may be disposed generally perpendicular to the outlet member longitudinal axis.

Within the first variation, each water outlet may further comprise a flow control member rotatably disposed within the outlet sleeve and the seal receiving chamber. The flow control member may have an axis of rotation and a central body. The flow control member may define an inlet opening, an outlet opening, and a flow control member passageway. The flow control member passageway may be in fluid communication with both the inlet opening and the outlet opening.

Within the first variation, each water outlet may further comprise a flow control seal coupled to the flow control member. The flow control seal may be coupled to the flow control member such that rotation of the flow control member causes the flow control seal to rotate within the seal receiving chamber between a fully obstructed range, a partially open range, and a fully open range to selectively place the outlet fluid passageway in fluid communication with the flow control member passageway.

Within the first variation, the flow control seal may have an annular shape, a first central opening axis, and a first radial axis. The flow control seal may define a first central opening. The first central opening axis may extend through and may be generally perpendicular to the first central opening. The first radial axis may be generally perpendicular to the first central opening axis.

Within the first variation, each water outlet may further comprise a downstream seal, which may be disposed about the central body and may be positioned downstream relative to the flow control seal along the flow control member passageway.

Within the first variation, the downstream seal may have an annular shape, a second central opening axis, and a second radial axis. The downstream seal may define a second central opening. The second central opening axis may extend through and be generally perpendicular to the second central opening. The second radial axis may be generally perpendicular to the second central opening axis,

Within the first variation, the second radial axis may be generally perpendicular to the axis of rotation, and the first radial axis may be disposed at an acute angle with respect to the axis of rotation.

Within the first variation, wherein the flow control seal may comprise a proximal portion and a distal portion. The proximal portion may be disposed closer to the downstream seal than the distal portion. The proximal portion may be disposed closer to the main body than the distal portion when the flow control member is in the fully open range.

Within the first variation, generally perpendicular may signify within 10° of being perfectly perpendicular, and the term generally parallel may signify within 10° of being perfectly parallel.

Within the first variation, the flow control seal may be an O-ring.

Within the first variation the first central opening axis may be a rotational axis of symmetry for the flow control seal.

Within the first variation, the second central opening axis may be a rotational axis of symmetry for the downstream seal.

A second variation of the irrigation manifold is also disclosed. The second variation may include a main body having a fluid inlet and a plurality of water outlets.

Within the second variation, each water outlet may comprise an outlet member defining a seal receiving chamber and an outlet fluid passageway. The outlet fluid passageway may be in fluid communication with the fluid inlet and the seal receiving chamber.

Within the second variation, each water outlet may further comprise an outlet sleeve.

Within the second variation, each water outlet may further comprise a flow control member rotatably disposed within the outlet sleeve and the seal receiving chamber, the flow control member having an axis of rotation and a central body, the flow control member defining an inlet opening, an outlet opening, and a flow control member passageway, the flow control member passageway being in fluid communication with both the inlet opening and the outlet opening,

Within the second variation, each water outlet may further comprise a flow control seal coupled to the flow control member. The flow control seal may be coupled to the flow control member such that rotation of the flow control member causes the flow control seal to rotate within the seal receiving chamber between a fully obstructed range, a partially open range, and a fully open range to selectively place the outlet fluid passageway in fluid communication with the flow control member passageway.

Within the second variation, the flow control seal may have an annular shape, a first central opening axis, and a first radial axis. The flow control seal may define a first central opening. The first central opening axis may extend through and may be generally perpendicular to the first central opening. The first radial axis may be generally perpendicular to the first central opening axis.

Within the second variation, each water outlet may further comprise a downstream seal, which may be disposed about the central body and may be positioned downstream relative to the flow control seal along the flow control member passageway.

Within the second variation, the downstream seal may have an annular shape, a second central opening axis, and a second radial axis. The downstream seal may define a second central opening. The second central opening axis may extend through and may be generally perpendicular to the second central opening. The second radial axis may be generally perpendicular to the second central opening axis.

Within the second variation, the second radial axis may be generally perpendicular to the axis of rotation, and the first radial axis may be disposed at an acute angle with respect to the axis of rotation.

Within the second variation, the flow control seal may comprise a proximal portion and a distal portion. The proximal portion may be disposed closer to the downstream seal than the distal portion. The proximal portion may be disposed closer to the main body than the distal portion when the flow control member is in the fully open range.

Within the second variation, generally perpendicular may signify within 10° of being perfectly perpendicular, and wherein the term generally parallel may signify within 10° of being perfectly parallel.

Within the second variation, wherein the flow control seal may be an O-ring.

Within the second variation, wherein the first central opening axis may be a rotational axis of symmetry for the flow control seal.

Within the second variation, the second central opening axis may be a rotational axis of symmetry for the downstream seal.

A third variation of an irrigation manifold is disclosed. The third variation may comprise a main body having a fluid inlet, and one or more water outlets.

Within the third variation, each water outlet may comprise an outlet member having an outlet member longitudinal axis. The outlet member may define a seal receiving chamber and an outlet fluid passageway. The outlet fluid passageway may be in fluid communication with the fluid inlet and the seal receiving chamber.

Within the third variation, each water outlet may further comprise an outlet sleeve having an outlet sleeve longitudinal axis. The outlet sleeve longitudinal axis may be disposed generally perpendicular to the outlet member longitudinal axis.

Within the third variation, each water outlet may further comprise a flow control member rotatably disposed within the outlet sleeve and the seal receiving chamber. The flow control member may have an axis of rotation and a central body. The flow control member may define an inlet opening, an outlet opening, and a flow control member passageway. The flow control member passageway may be in fluid communication with both the inlet opening and the outlet opening,

Within the third variation, each water outlet may further comprise a flow control seal coupled to the flow control member. The flow control seal may be coupled to the flow control member such that rotation of the flow control member causes the flow control seal to rotate within the seal receiving chamber between a fully obstructed range, a partially open range, and a fully open range to selectively place the outlet fluid passageway in fluid communication with the flow control member passageway.

Within the third variation, the flow control seal may have an annular shape and a first radial axis. The flow control seal may have an annular shape, a first central opening axis, and a first radial axis. The flow control seal may define a first central opening. The first central opening axis may extend through and may be generally perpendicular to the first central opening. The first radial axis may be generally perpendicular to the first central opening axis.

Within the third variation, each water outlet may further comprise a downstream seal, which may be disposed about the central body and may be positioned downstream relative to the flow control seal along the flow control member passageway.

Within the third variation, the downstream seal may have an annular shape, a second central opening axis, and a second radial axis. The downstream seal may define a second central opening. The second central opening axis may extend through and may be generally perpendicular to the second central opening. The second radial axis may be generally perpendicular to the second central opening axis,

Within the third variation, the second radial axis may be generally perpendicular to the axis of rotation, and the first radial axis may be disposed at an acute angle with respect to the axis of rotation.

Within the third variation, the upstream flow control seal may comprise a proximal portion and a distal portion. The proximal portion may be disposed closer to the downstream seal than the distal portion. The proximal portion may be disposed closer to the main body than the distal portion when the flow control member is in the fully open range.

Within the third variation, the flow control seal may be an O-ring.

Within the third variation, generally perpendicular may signify within 10° of being perfectly perpendicular, and the term generally parallel may signify within 10° of being perfectly parallel.

Within the third variation, wherein the first central opening axis may be a rotational axis of symmetry for the flow control seal.

Within the third variation, the second central opening axis may be a rotational axis of symmetry for the downstream seal.

### BRIEF DESCRIPTION OF THE DRAWINGS

Illustrative embodiments of the invention will become more fully apparent from the following description and appended claims, taken in conjunction with the accompanying drawings. Understanding that these drawings depict only illustrative embodiments and are, therefore, not to be considered limiting of the invention’s scope, the illustrative embodiments of the invention will be described with additional specificity and detail through use of the accompanying drawings in which:

FIG. 1 is a side view of an irrigation manifold shown together with a riser and with tubing connected to a few of the flow control members;

FIG. 2 is a top perspective view of the irrigation manifold shown in FIG. 1;

FIG. 3 is a side view of the irrigation manifold shown in FIG. 1;

FIG. 4 is an exploded view of the irrigation manifold shown in FIG. 1;

FIG. 5 is a side cross-sectional view taken across the line 5–5 of FIG. 3, with each depicted flow upstream seal, flow control seal, and downstream seal presented in this figure shown in a full, non-cross-sectional view;

FIG. 6A is a side view of two seals (a flow control seal and a downstream seal) used in connection with the flow control member of the irrigation manifold of FIG. 1;

FIG. 6B is a perspective view of the two seals illustrated in FIG. 6A;

FIG. 7 as a side view of one of the water outlets of the irrigation manifold of FIG. 1; and

FIG. 8A is a top cross-sectional view of a water outlet taken across the line 8A–8A of FIG. 7, while FIGS. 8B–8H provide the same view but illustrate a flow control member in alternate positions, thereby illustrating the flow control member in a fully open range, a partially open range, and a fully obstructed range.

### DETAILED DESCRIPTION

Various aspects of the present disclosure are described below. It should be apparent that the teachings herein may be embodied in a wide variety of forms and that any specific structure, function, or both disclosed herein is merely representative. Based on the teachings herein, one skilled in the art should appreciate that an aspect disclosed herein may be implemented independently of any other aspects and that two or more of these aspects may be combined in various ways, even if that combination is not specifically illustrated in the figures or description. For example, an apparatus may be implemented, or a method may be practiced, using any number of the aspects set forth herein whether disclosed in connection with a method or an apparatus. Further, the disclosed apparatuses and methods may be practiced using structures or functionality known to one of skill in the art at the time this application was filed, although not specifically disclosed within the application.

### Definitions and Terminology

This section provides introductory definitions for terms used in this application. Additional definitions may appear within the context of specific figure discussions. The term “exemplary,” as used herein, denotes an example, implementation, or aspect of the disclosed subject matter without indicating preference for any particular implementation.

Ordinal terms such as “first” or “second” are provided for identification and ease of reference. They do not necessarily imply physical characteristics or ordering unless explicitly stated. Therefore, this terminology distinguishes elements with similar names, such as “first element” and “second element,” rather than indicating priority or sequence.

Indefinite articles like “a” and “an” signify “one or more” rather than “one.”

When describing a structure or operation that “comprises” or “includes” an element, additional elements not explicitly mentioned may also be included. Therefore, the terms “including,” “comprising,” and “having” should be understood as “including but not limited to” unless expressly stated otherwise. Similarly, an operation described as occurring “based on” a condition or event may also depend on other conditions or events not explicitly mentioned.

The terms “an embodiment,” “one embodiment,” or “another embodiment” do not refer to a single variation of the disclosed subject matter. Instead, they indicate that multiple variations may be applied to different implementations.

A “set” may include one or more of each item coming within the specified “set.” Therefore, unless otherwise explicitly specified a set may include a single item or a plurality of items.

An enumerated list of items in connection with an embodiment does not imply exclusivity or inclusivity unless specifically stated otherwise.

### Relationship and Attachment Terminology

The phrases “secured to,” “connected to,” “coupled to,” and “in communication with” refer to any interaction between entities, including mechanical, electrical, magnetic, electromagnetic, or thermal interactions, as well as fluid communication. “Attached to” refers to mechanical coupling that restricts relative translation or rotation, while “pivotally attached to” and “slidably attached to” allow relative rotation or translation, respectively.

The phrase “attached directly to” indicates attachment with direct contact or separation by a single fastener, adhesive, or similar mechanism. The term “abut” denotes items in direct physical contact, whether attached, fused, or welded.

“Integrally formed” describes items manufactured as a single piece without requiring assembly. Conversely, “separately manufactured” indicates items that are not integrally formed, whether by different processes, or at different times, or locations.

### Alignment and Positioning Terminology

The term “substantially coaxially aligned” indicates that two items share a common imaginary axis or are within 15° of sharing a common imaginary axis. The items may be spaced apart along this axis.

The term “offset and substantially coaxially aligned” refers to items sharing a common imaginary axis, with their center points spaced apart along this common imaginary axis.

“Overlapping and substantially coaxially aligned” refers to items that overlap along a common imaginary axis while remaining aligned.

“Coextensive and substantially coaxially aligned” describes items sharing a common axis and extending over the same distance along the axis.

“Center point nonalignment” signifies that the center points of each of the two identified items are not aligned along a designated axis.

“Center point alignment” signifies that the center points of each of the two identified items are aligned with at least one designated axis or perspective (e.g., from a top view or a side view).

“Outer boundary nonalignment” refers to items whose outer boundaries are not aligned along a designated axis. “Nonaligned positions” indicates that two items are not aligned along at least one axis, covering both center point and outer boundary nonalignment.

The term “generally” indicates an orientation or value within 10° of the specified angle, while “substantially” indicates a value within 10% of the specified value. Therefore, for example, “generally parallel” indicates components are within 10° of being perfectly parallel, and “generally perpendicular” indicates that the identified components are within 10° of being perfectly perpendicular.

### Reference Numerals in The Figures

While certain components may appear multiple times in a drawing, not all instances will be labeled to preserve the clarity of the figures. Descriptions will clarify which specific instances are referenced, even if not explicitly labeled in the figures.

### Grouping of Figures

Based on the headings provided below, certain figures will be discussed as a group. The part names and reference numerals discussed in such a group will not necessarily appear in all of the figures in the group but will appear in at least one figure within the group.

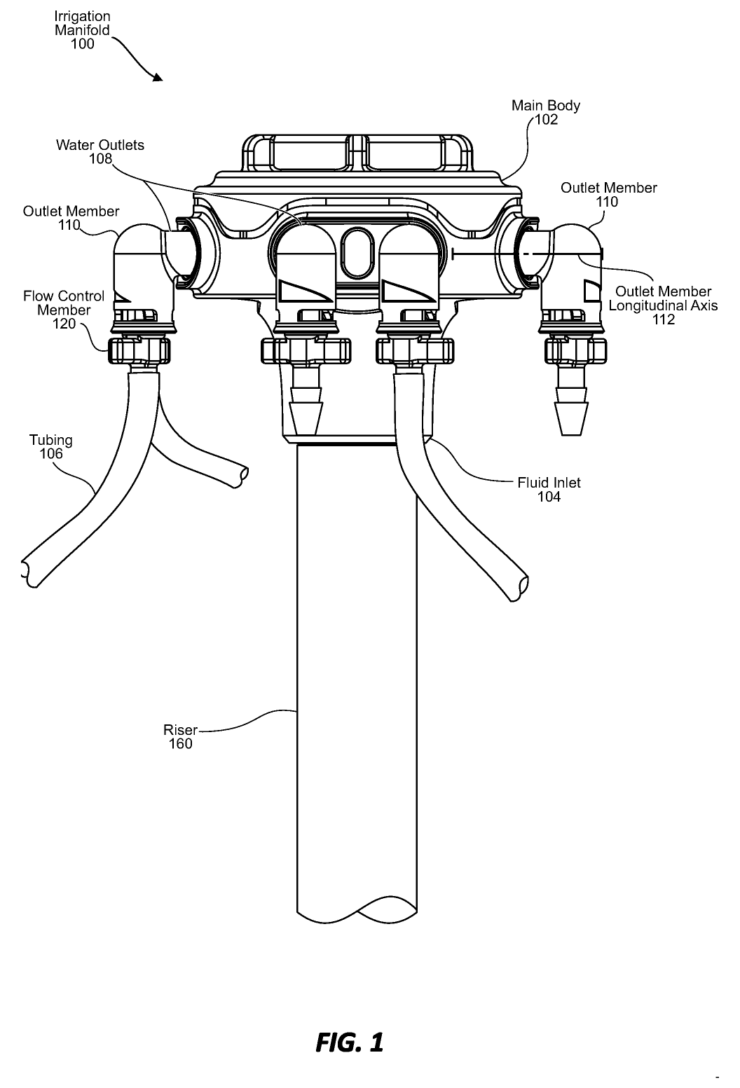

Description of FIGS. 1 to 5

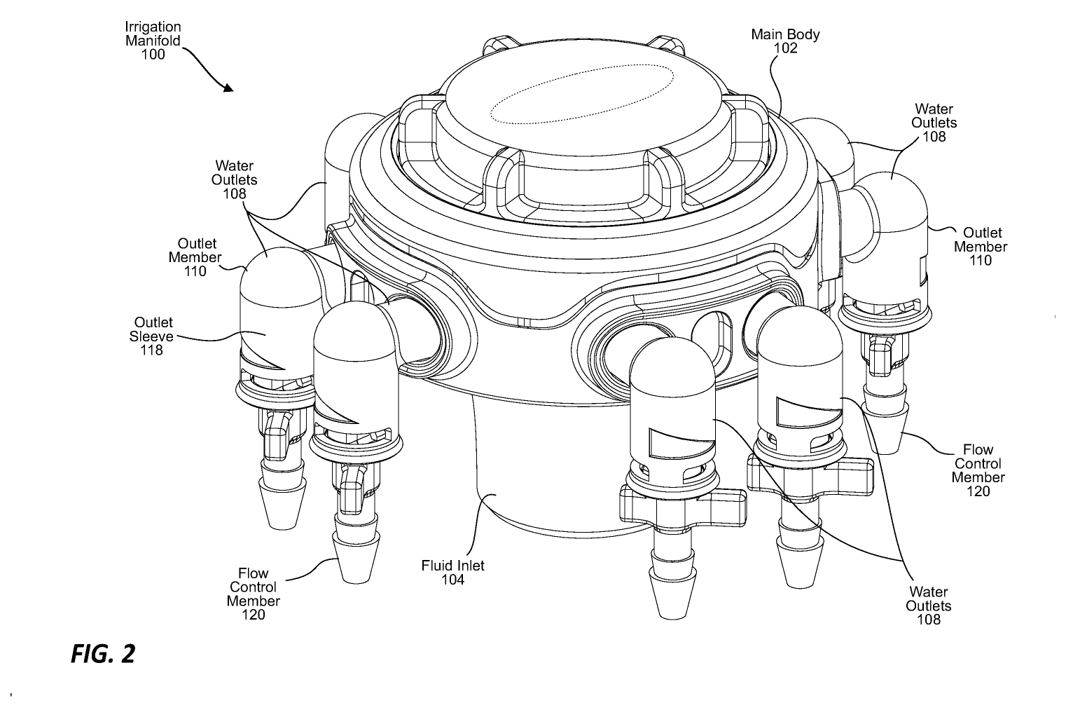

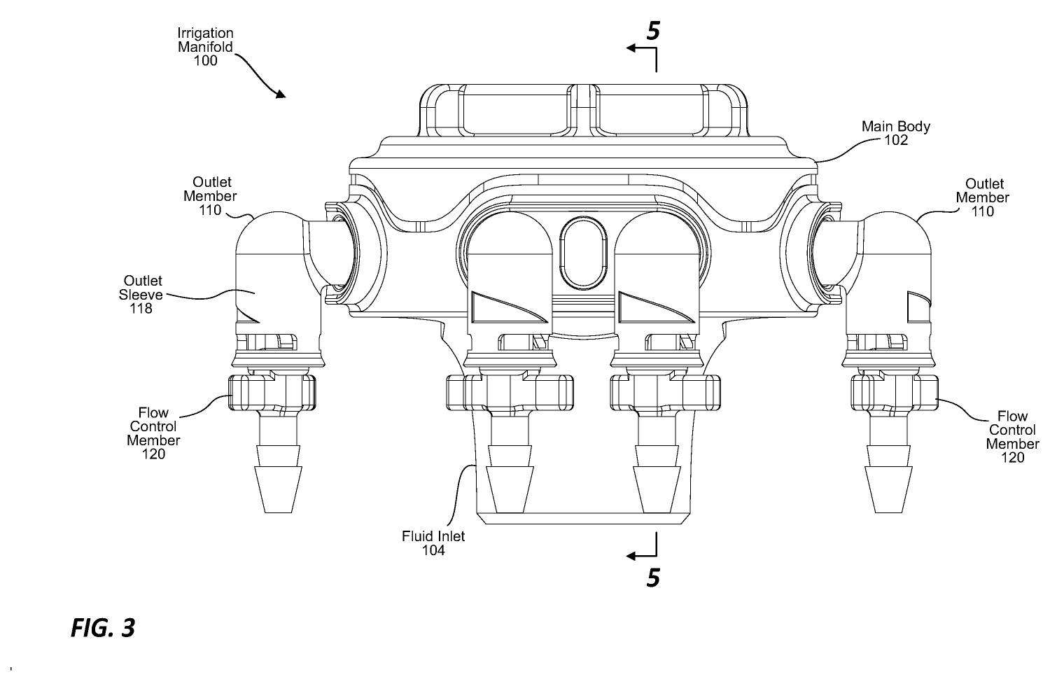

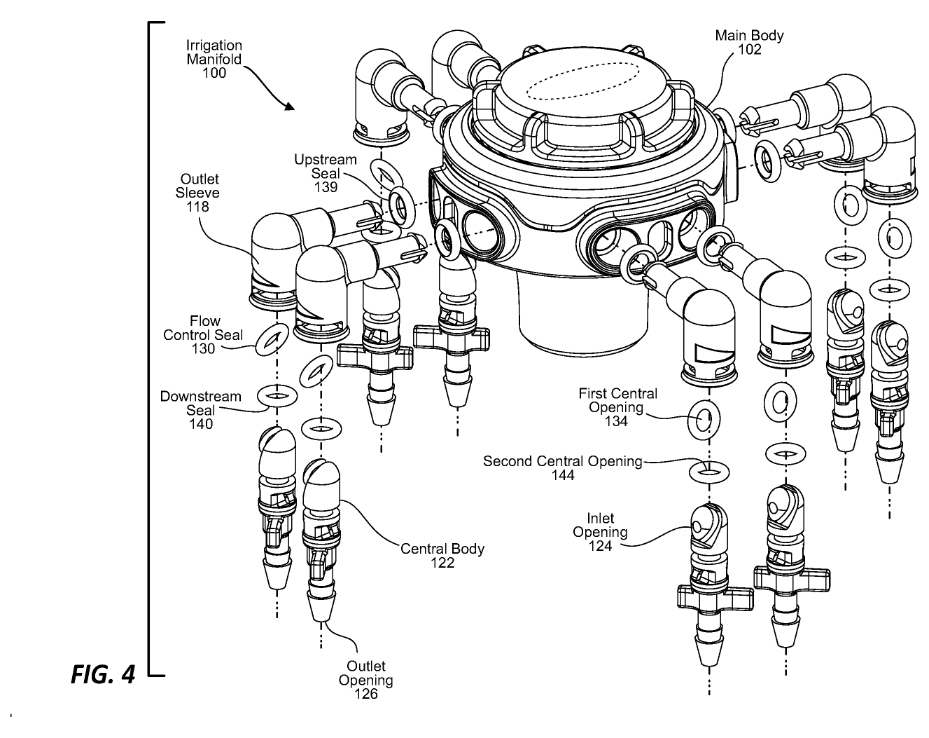

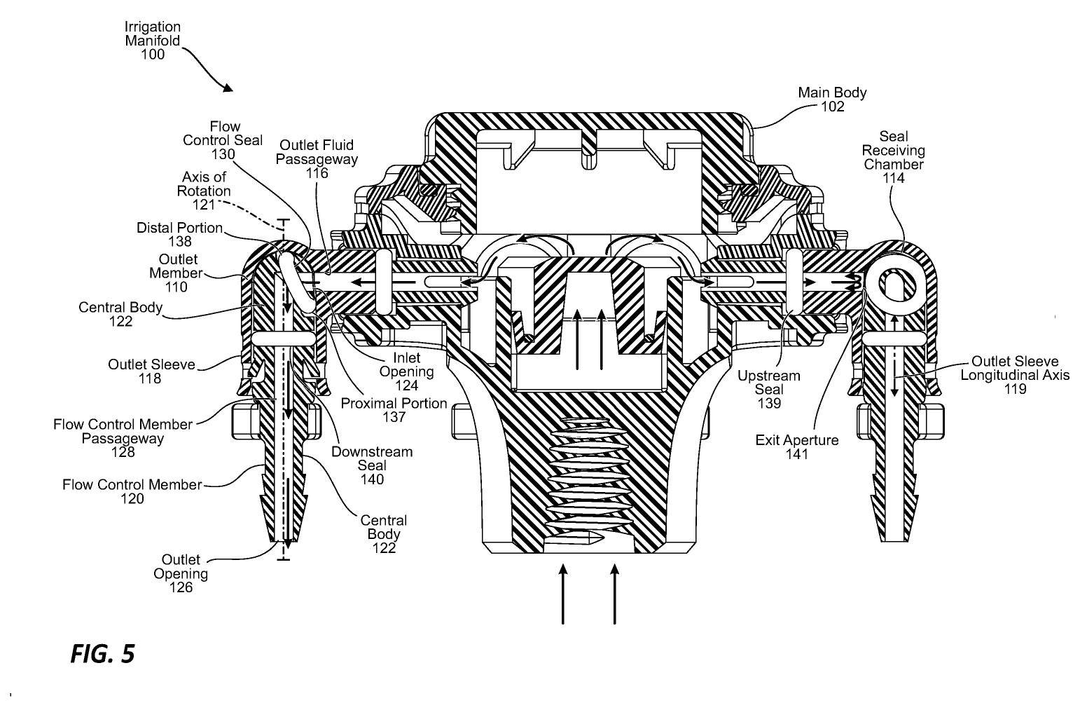

Referring now collectively to FIGS. 1-5, FIG. 1 is a side view of an irrigation manifold 100 shown together with a riser 160 and with tubing 106 connected to a few of the flow control members 120. FIG. 2 is a top perspective view of the irrigation manifold 100, while FIG. 3 is a side view. FIG. 4 is an exploded view of the irrigation manifold 100. FIG. 5 is a side cross-sectional view taken across the line 5–5 of FIG. 3 with each depicted upstream seal 139, flow control seal 130, and downstream seal 140 presented in this figure shown in a full, non-cross-sectional view.

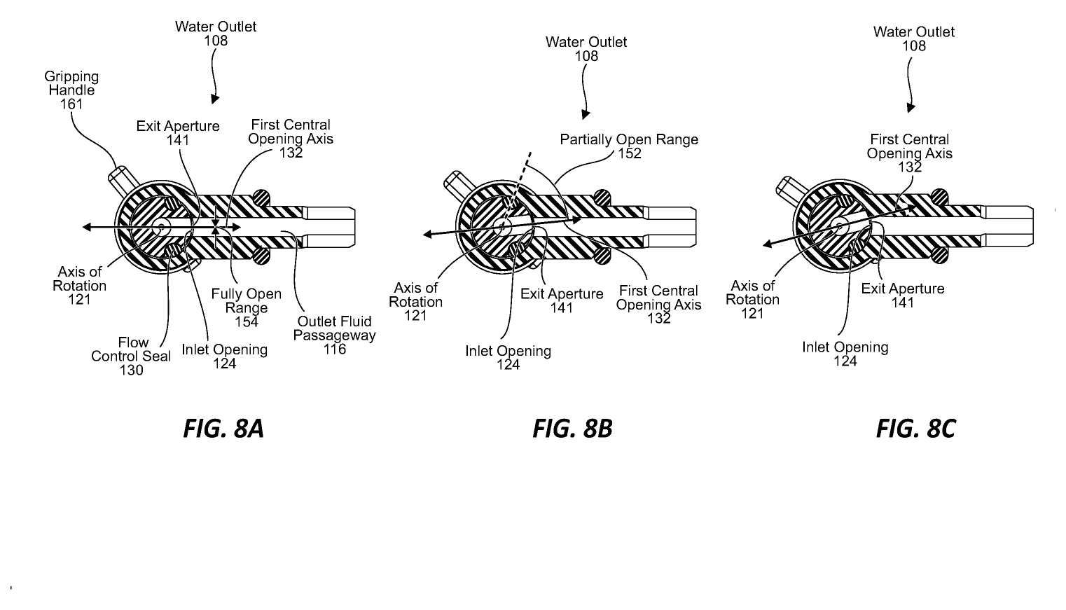

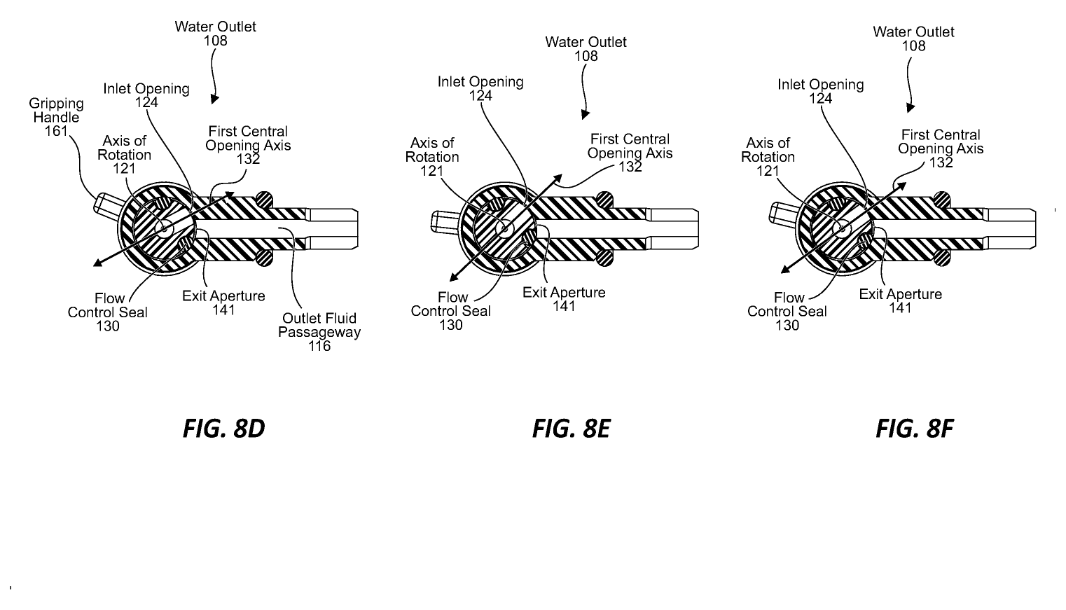

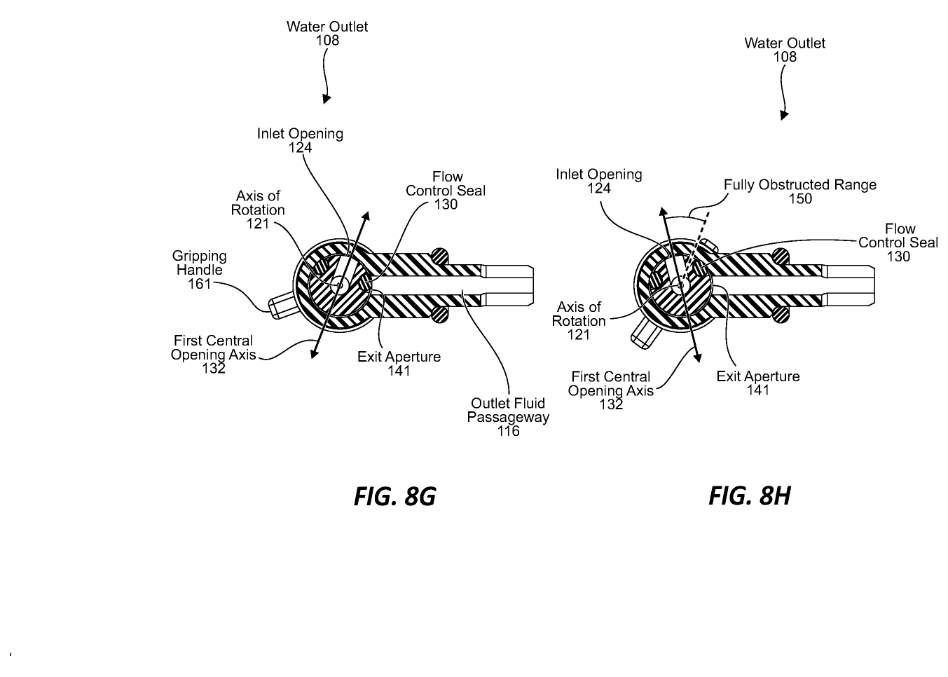

The irrigation manifold 100 may comprise a main body 102, various water outlets 108, and a fluid inlet 104. The fluid inlet 104 may be connected to a riser 160 through which water may flow into the irrigation manifold 100. The water will then pass through the main body 102 and flow to the water outlets 108. Each water outlet 108 may include a water outlet member 110 and a flow control member 120. Depending on the position of the flow control member 120, water may flow out of the flow control member 120 into tubing 106. The flow control member 120, being rotatable between a fully open range, a partially open range, or a fully open range (which ranges are illustrated in FIGS. 8A–8H), controls the volume of water flowing through each pertinent flow control member 120.

Each outlet member 110 may define an outlet fluid passageway 116 and a seal receiving chamber 114. The outlet fluid passageway 116 may be in fluid communication with the seal receiving chamber 114 (via an exit aperture 141) and the fluid inlet 104. The outlet member longitudinal axis 112 extends along the fluid outlet passageway 116. The flow control member 120 may be rotatably disposed within an outlet sleeve 118 and the seal receiving chamber 114. The outlet sleeve 118 may include an outlet sleeve longitudinal axis 119. In various embodiments, the outlet sleeve longitudinal axis 119 is generally perpendicular to the outlet member longitudinal axis 112.

The flow control member 120 has an axis of rotation 121 about which the flow control member 120 rotates when disposed within the outlet sleeve 118 and the seal receiving chamber 114. The flow control member 120 also includes a central body 122. The flow control member 120 defines an inlet opening 124, a flow control member passageway 128, and an outlet opening 126 (which is also the fluid outlet of each water outlet 108). The flow control member passageway 128 is in fluid communication with the inlet opening 124 and the outlet opening 126.

Each of the water outlets 108 includes an upstream seal 139, a flow control seal 130, and a downstream seal 140. Each upstream seal 139, flow control seal 130, and downstream seal 140 may be annular in shape and, in certain embodiments, as illustrated in the figures, may comprise O-ring seals.

Each flow control seal 130 may include a first central opening 134, while the downstream seal 140 may include a second central opening 144. A proximal portion 137 of the flow control seal 130 is disposed closer to the downstream seal 140 than the distal portion 138. As illustrated, the proximal portion 137 is disposed closer to the main body 102 than the distal portion 138 when the flow control member 120 is in a fully open range 154, which will be illustrated in FIG. 8A. In various alternative embodiments, which are not illustrated, the proximal portion 136 is disposed farther away from the main body 102 than the distal portion 138 when the flow control member 120 is in a fully open range 154.

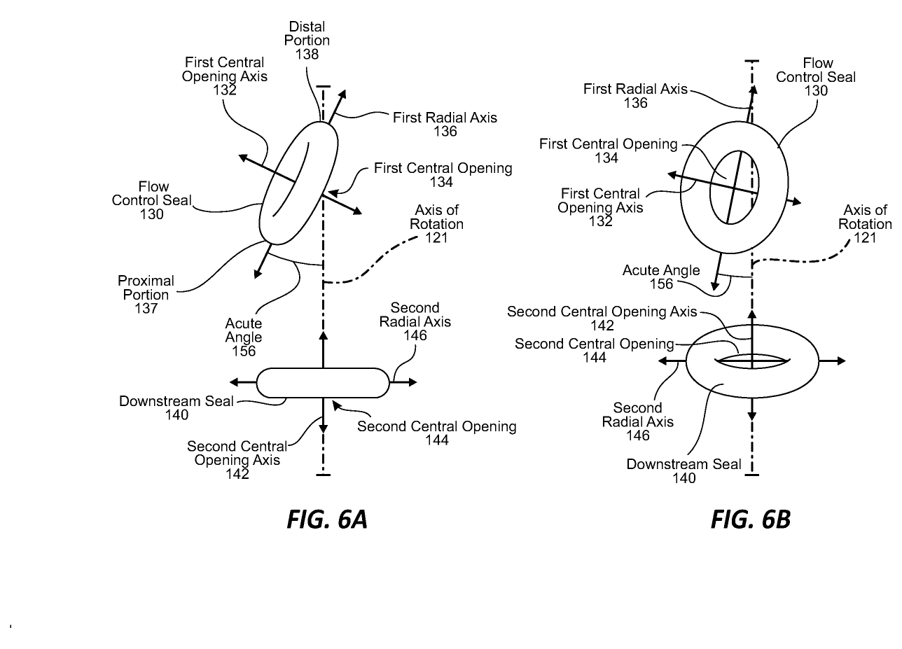

Description of FIGS. 6A to 6B

FIGS. 6A and 6B illustrate the relative positions of the flow control seal 130 and the downstream seal 140. As illustrated, the flow control seal 130 may include a first central opening 134 with a first central opening axis 132 extending through and being generally perpendicular to a first central opening axis 132. A first radial axis 136 extends radially away from and is generally perpendicular to the first central opening axis 132. The first radial axis 136 is disposed at an acute angle 156 with respect to the axis of rotation 121. The first central opening axis 132 may comprise a rotational axis of symmetry for the flow control seal 130. Therefore, the flow control seal 130 appears the same when rotated about the first central opening axis 132.

The downstream seal 140 may include a second central opening 144 with a second central opening axis 142. As illustrated, the second central opening axis 142 extends through and is generally perpendicular to the second central opening 144. The second radial axis 146 is generally perpendicular to the second central opening axis 142 and extends radially away from the second central opening axis 142. The second central opening axis 142 may comprise a rotational axis of symmetry for the downstream seal 140. Again, this signifies that the downstream seal 140 appears identical when rotated about a second central opening axis 142. It should also be noted that the axis of rotation 121 may be in the same location as the second central opening axis 142, as illustrated in FIGS. 6A and 6B, and therefore may also serve as a rotational axis of symmetry for the downstream seal 140.

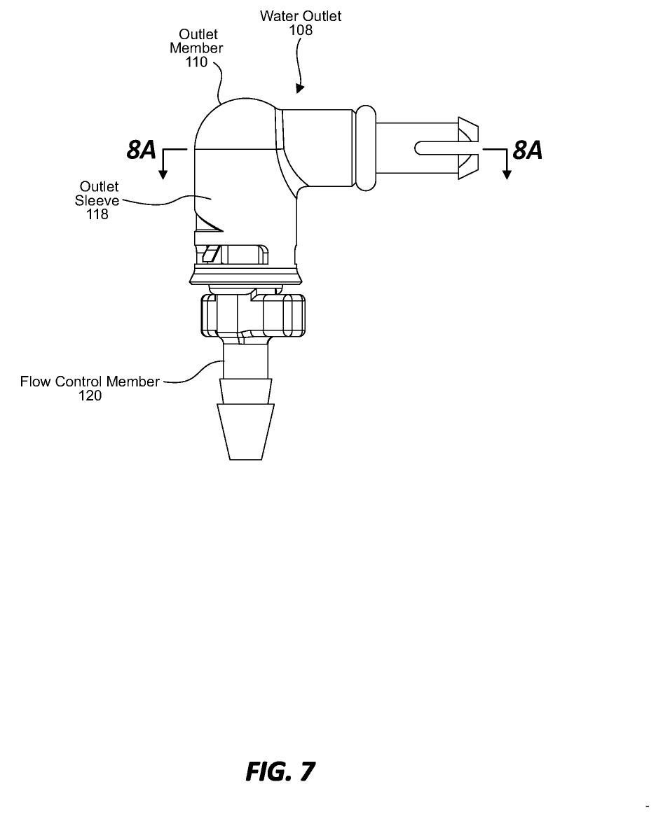

Description of FIGS. 7 to 8H

FIG. 7 is a side view of a water outlet 108, including an outlet member 110, outlet sleeve 118, and a flow control member 120. FIG. 8A is a top cross-sectional view of a water outlet 108 taken across the line 8A–8A, while FIGS. 8B-8H provide the same view but illustrate a flow control member 120 in alternate positions, thereby illustrating the flow control member a fully open range 154, a partially open range 152, and a fully obstructed range 150.

As illustrated, the flow control member 120 is rotatable about the axis of rotation 121 such that the exit aperture 141 of the outlet fluid passageway 116 may be aligned with the inlet opening 124 of the flow control member passageway 128. In this state, as illustrated in FIG. 8A, the first central opening axis 132 may be aligned with the outlet fluid passageway 116 when the flow control member 120 is in a fully open range 154. It should be noted that in certain embodiments, the exit aperture 141 and the inlet opening 124 may be of different sizes. In this scenario, the exit aperture 141 and the inlet opening 124 are aligned when a center point of the exit aperture 141 and a center point of the inlet opening 124 are aligned from at least one perspective (e.g., from a top view (as illustrated in FIG. 8A) or a side view), as illustrated in FIG. 8A. As indicated previously, this may be referred to as “center point alignment.”

As illustrated in FIGS. 8B-8F, the flow control member 120 may be rotated in a counterclockwise direction using the gripping handle 161 to go through various stages of a partially open range 152, in which the inlet opening 124 is only partially aligned with the exit aperture 141 (as illustrated in FIGS. 8B-8D) or the inlet opening 124 and the exit aperture 141 are in complete nonalignment but before the flow control seal 130 completely obstructs the exit aperture 141 (as illustrated in FIGS. 8E-8F). As fluid communication between the inlet opening 124 and the exit aperture 141 decreases, the flow through the flow control member 120 and from water outlet 108 decreases. As illustrated in FIGS. 8G-8H, at some point in the counterclockwise rotation (again, using the gripping handle 161), the flow control seal 130 will contact the outlet member 110 and completely obstruct the flow of water through the flow control member 120. As a consequence, the flow control member 120 may be positioned within a fully obstructed range 150, in which water does not flow through the flow control member 120. It should be noted that the disclosed design provides users with a single user interface (i.e., the gripping handle 161 of the flow control member 120), to control the flow of water, including completely shutting off the flow, through each water outlet 108.

### CONCLUSION

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods, systems and components of the subject matter disclosed herein without departing from the spirit and scope of the invention. For example, in alternative embodiments, the flow control member 120 may rotate in a clockwise direction to move from a fully open range 154, through a partially open range 152, and to a fully obstructed range 150. Also, as noted previously, the flow control seal 130 may be disposed at an acute angle 156 with respect to the axis of rotation 121 with the distal portion 138 being closer to the main body 102 than the proximal portion 137 when the flow control member 120 is in a fully open range 154. Also, the flow control seal 130 and downstream seal 140 may be annular in shape but not necessarily be an O-ring style seal. In addition, the number of water outlets 108 may be varied within the scope of the disclosed subject matter. It should be noted that the specifically cited variations and alterations serve only as examples. Again, those skilled in the art may appreciate that the disclosed subject matter is only illustrative of the pertinent principles and components.

1. An irrigation manifold, comprising:
a main body having a fluid inlet;
a plurality of water outlets, each water outlet comprising:
an outlet member having an outlet member longitudinal axis, the outlet member defining a seal receiving chamber and an outlet fluid passageway, the outlet fluid passageway being in fluid communication with the fluid inlet and the seal receiving chamber;
an outlet sleeve having an outlet sleeve longitudinal axis, wherein outlet sleeve longitudinal axis is disposed generally perpendicular to the outlet member longitudinal axis;
a flow control member rotatably disposed within the outlet sleeve and the seal receiving chamber, the flow control member having an axis of rotation and a central body, the flow control member defining an inlet opening, an outlet opening, and a flow control member passageway, the flow control member passageway being in fluid communication with both the inlet opening and the outlet opening;
a flow control seal coupled to the flow control member, the flow control seal being coupled to the flow control member such that rotation of the flow control member causes the flow control seal to rotate within the seal receiving chamber between a fully obstructed range, a partially open range, and a fully open range to selectively place the outlet fluid passageway in fluid communication with the flow control member passageway;
the flow control seal having an annular shape, a first central opening axis, and a first radial axis, the flow control seal defining a first central opening, the first central opening axis extending through and being generally perpendicular to the first central opening, the first radial axis being generally perpendicular to the first central opening axis; and
a downstream seal disposed about the central body and being positioned downstream relative to the flow control seal along the flow control member passageway;
the downstream seal having an annular shape, a second central opening axis, and a second radial axis, the downstream seal defining a second central opening, the second central opening axis extending through and being generally perpendicular to the second central opening, the second radial axis being generally perpendicular to the second central opening axis;
wherein the second radial axis is generally perpendicular to the axis of rotation, and the first radial axis is disposed at an acute angle with respect to the axis of rotation.

2. The irrigation manifold of claim 1, wherein the flow control seal comprises a proximal portion and a distal portion, the proximal portion being disposed closer to the downstream seal than the distal portion, wherein the proximal portion is disposed closer to the main body than the distal portion when the flow control member is in the fully open range.

3. The irrigation manifold of claim 1, wherein generally perpendicular signifies within 10° of being perfectly perpendicular, and wherein generally parallel signifies within 10° of being perfectly parallel.

4. The irrigation manifold of claim 1, wherein the flow control seal is an O-ring.

5. The irrigation manifold of claim 1, wherein the first central opening axis is a rotational axis of symmetry for the flow control seal.

6. The irrigation manifold of claim 5, wherein the second central opening axis is a rotational axis of symmetry for the downstream seal.

7. An irrigation manifold, comprising:
a main body having a fluid inlet;
a plurality of water outlets, each water outlet comprising:
an outlet member defining a seal receiving chamber and an outlet fluid passageway, the outlet fluid passageway being in fluid communication with the fluid inlet and the seal receiving chamber;
an outlet sleeve;
a flow control member rotatably disposed within the outlet sleeve and the seal receiving chamber, the flow control member having an axis of rotation and a central body, the flow control member defining an inlet opening, an outlet opening, and a flow control member passageway, the flow control member passageway being in fluid communication with both the inlet opening and the outlet opening;
a flow control seal coupled to the flow control member, the flow control seal being coupled to the flow control member such that rotation of the flow control member causes the flow control seal to rotate within the seal receiving chamber between a fully obstructed range, a partially open range, and a fully open range to selectively place the outlet fluid passageway in fluid communication with the flow control member passageway;
the flow control seal having an annular shape, a first central opening axis, and a first radial axis, the flow control seal defining a first central opening, the first central opening axis extending through and being generally perpendicular to the first central opening, the first radial axis being generally perpendicular to the first central opening axis;
a downstream seal disposed about the central body and being positioned downstream relative to the flow control seal along the flow control member passageway;
the downstream seal having an annular shape, a second central opening axis, and a second radial axis, the downstream seal defining a second central opening, the second central opening axis extending through and being generally perpendicular to the second central opening, the second radial axis being generally perpendicular to the second central opening axis; and
wherein the second radial axis is generally perpendicular to the axis of rotation, and the first radial axis is disposed at an acute angle with respect to the axis of rotation.

8. The irrigation manifold of claim 7, wherein the flow control seal comprises a proximal portion and a distal portion, the proximal portion being disposed closer to the downstream seal than the distal portion, wherein the proximal portion is disposed closer to the main body than the distal portion when the flow control member is in the fully open range.

9. The irrigation manifold of claim 7, wherein generally perpendicular signifies within 10° of being perfectly perpendicular, and wherein generally parallel signifies within 10° of being perfectly parallel.

10. The irrigation manifold of claim 7, wherein the flow control seal is an O-ring.

11. The irrigation manifold of claim 7, wherein the first central opening axis is a rotational axis of symmetry for the flow control seal.

12. The irrigation manifold of claim 9, wherein the second central opening axis is a rotational axis of symmetry for the downstream seal.

13. An irrigation manifold, comprising:
a main body having a fluid inlet;
one or more water outlets, each water outlet comprising:
an outlet member having an outlet member longitudinal axis, the outlet member defining a seal receiving chamber and an outlet fluid passageway, the outlet fluid passageway being in fluid communication with the fluid inlet and the seal receiving chamber;
an outlet sleeve;
a flow control member rotatably disposed within the outlet sleeve and the seal receiving chamber, the flow control member having an axis of rotation and a central body, the flow control member defining an inlet opening, an outlet opening, and a flow control member passageway, the flow control member passageway being in fluid communication with both the inlet opening and the outlet opening;
a flow control seal coupled to the flow control member, the flow control seal being coupled to the flow control member such that rotation of the flow control member causes the flow control seal to rotate within the seal receiving chamber between a fully obstructed range, a partially open range, and a fully open range to selectively place the outlet fluid passageway in fluid communication with the flow control member passageway;
the flow control seal having an annular shape, a first central opening axis, and a first radial axis, the flow control seal defining a first central opening, the first central opening axis extending through and being generally perpendicular to the first central opening, the first radial axis being generally perpendicular to the first central opening axis;
a downstream seal disposed about the central body and being positioned downstream relative to the flow control seal along the flow control member passageway;
the downstream seal having an annular shape, a second central opening axis, and a second radial axis, the downstream seal defining a second central opening, the second central opening axis extending through and being generally perpendicular to the second central opening, the second radial axis being generally perpendicular to the second central opening axis; and
wherein the second radial axis is generally perpendicular to the axis of rotation, and the first radial axis is disposed at an acute angle with respect to the axis of rotation.

14. The irrigation manifold of claim 13, wherein the flow control seal comprises a proximal portion and a distal portion, the proximal portion being disposed closer to the downstream seal than the distal portion, wherein the proximal portion is disposed closer to the main body than the distal portion when the flow control member is in the fully open range.

15. The irrigation manifold of claim 13, wherein generally perpendicular signifies within 10° of being perfectly perpendicular, and wherein generally parallel signifies within 10° of being perfectly parallel.

16. The irrigation manifold of claim 13, wherein the flow control seal is an O-ring.

17. The irrigation manifold of claim 13, wherein the first central opening axis is a rotational axis of symmetry for the flow control seal.

18. The irrigation manifold of claim 17, wherein the second central opening axis is a rotational axis of symmetry for the downstream seal.
